(19) United States
(12) Patent Application Publication
(10) Pub. No.: US 2005/0072523 A1
(43) Pub. Date: Apr. 7, 2005

(54) Device and method for using a heating layer to replace a touch screen

(76) Inventors: Kurt Businger, Warwick, RI (US); Laurence Tremaine, Warwick, RI (US)

Correspondence Address: Andrew L. Reibman, Esq.;KENYON & KENYON, One Broadway, New York, NY, 10004, US

(21) Appl. No.: 10/678,238

(22) Filed: Oct. 3, 2003

(51) Int. Cl. B32B 1/00; B32B 31/00

(52) U.S. Cl. 156/344; 156/581; 156/584; 219/535

(57) ABSTRACT

A device and method for replacing a touch screen is disclosed. The device includes a heating layer configured to be disposed in close proximity to a monitor having a touch screen adhered to its front surface. The method includes disposing the heating layer so that the touch screen adhered to the font of the heating monitor is in contact with the heating layer, heating the surface of the touch screen, and removing the touch screen from a front surface of the monitor.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

In order to provide touch screen capabilities to a monitor that is not originally equipped with a touch screen, touch screens may be adhered to the front of monitors using, for example, an adhesive. In the gaming industry, for example, gaming terminals having monitors equipped with touch screens may be more attractive to game players than those requiring use of a keyboard. By adhering a touch screen to an already existing gaming terminal monitor, the gaming terminal operator may save the cost of having to purchase an entirely new machine.

Different types of touch screens may be used. For example, 4 or 5 wire resistive touch screens, capacitive touch screens, surface acoustic wave touch screens, near field imaging touch screens, infrared touch screens, or pen/stylus compatible touch screens may be used. The various types have associated advantages and disadvantages, such as amount of resolution, susceptibility to interference, and expense. Touch screens may be fitted to a variety of monitors and displays, both analog and digital, such as, cathode ray tube (CRT) monitors, flat square tube monitors, flat panel displays or liquid crystal displays (plasma displays), active or passive matrix displays, or thin film transistor displays.

Different materials and methods may be used to apply the touch screen, such as, an adhesive or a tape layer, or a mechanical device, such a screw, clamp, or combination thereof. For example, a resistive touch screen may be applied to the front of a monitor. A resistive touch screen may include a conductive layer, a separation layer including a sensor arrangement, and a resistive layer. The sensor arrangement within the touch screen may be coupled to devices that facilitate the transfer of information from the touch screen sensor arrangement. For example, a processor, which controls the monitor, may be used. Other devices that may be used include, for example, a controller and a software driver. Over time, the accuracy of the touch screen may diminish due to environmental influences, misuse, ordinary wear and tear, or accidental damage.

Some manufacturers and/or retailers of such touch screen equipped monitors offer services to replace touch screens that are broken or malfunctioning. However, such services may be expensive for the purchaser of the touch screen equipped monitors, for example, if the touch screen malfunctions after the exhaustion of the period covered by a warranty. Furthermore, a purchaser of a large quantity of touch screen equipped monitors may have relocated the monitors a great distance from the manufacturer, therefore, the shipping cost alone of sending a large quantity of monitors back to the manufacturer would be prohibitively expensive.

One method of removing a touch screen that has been adhered to the surface of a monitor is to insert the face of the monitor into an oven type of heating device. This device may require a large amount of space and be quite costly to maintain. Furthermore, such a method may require that the operator possess very specialized knowledge of the oven device to prevent damage to the monitor or injury to the operator from occurring during the heating process.

### BRIEF DESCRIPTION OF THE DRAWINGS

FIG. 1 illustrates an example touch screen adhered to a monitor.

FIG. 2 illustrates an example heating device, according to an example embodiment of the present invention.

FIG. 3A illustrates an example arrangement of a touch screen equipped monitor on the heating device, according to an example embodiment of the present invention.

FIG. 3B illustrates an example touch screen equipped monitor after removal of the touch screen, according to an example embodiment of the present invention.

FIG. 4 illustrates an example procedure for removing a touch screen, according to an example embodiment of the present invention.

### DETAILED DESCRIPTION OF THE EXAMPLE EMBODIMENTS

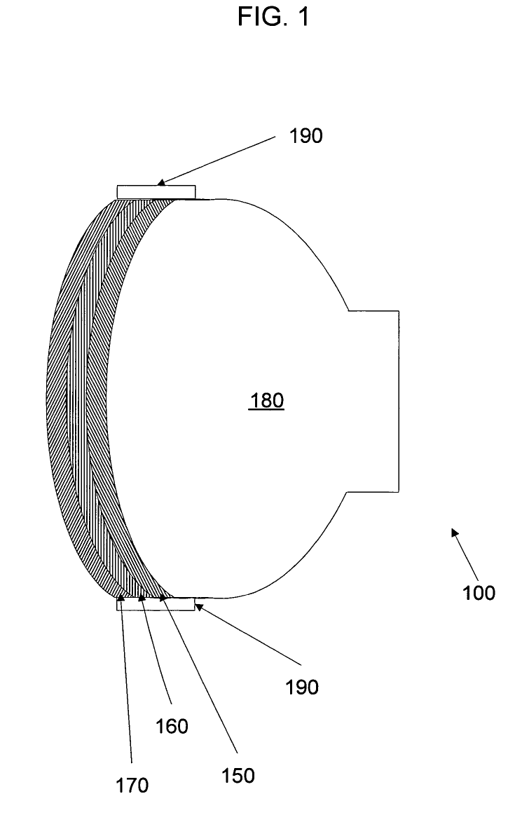

FIG. 1 illustrates an example touch screen adhered to the front panel of an example monitor. The monitor 100 may include a cover 180 and a display surface 150. The display surface 150 may be made of, for example, glass, plexiglass, or plastic, or any conventional monitor display material. A bonding arrangement consisting of one or more adhesives 160 may be applied to the surface and/or the edges of display surface 150. The adhesive 160 may be made of an epoxy, for example, a ⅛ inch thick layer of optically clear epoxy may be used. The touch screen 170, may be placed over the adhesive layer 160 such that it may be directly bonded to display surface 150. Additional securing measures may be added, for example, tape 190 may be used to secure and seal the edges. If a capacitive touch screen is being used, the tape layer may also act as an insulating layer to protect the electronic components within the touch screen.

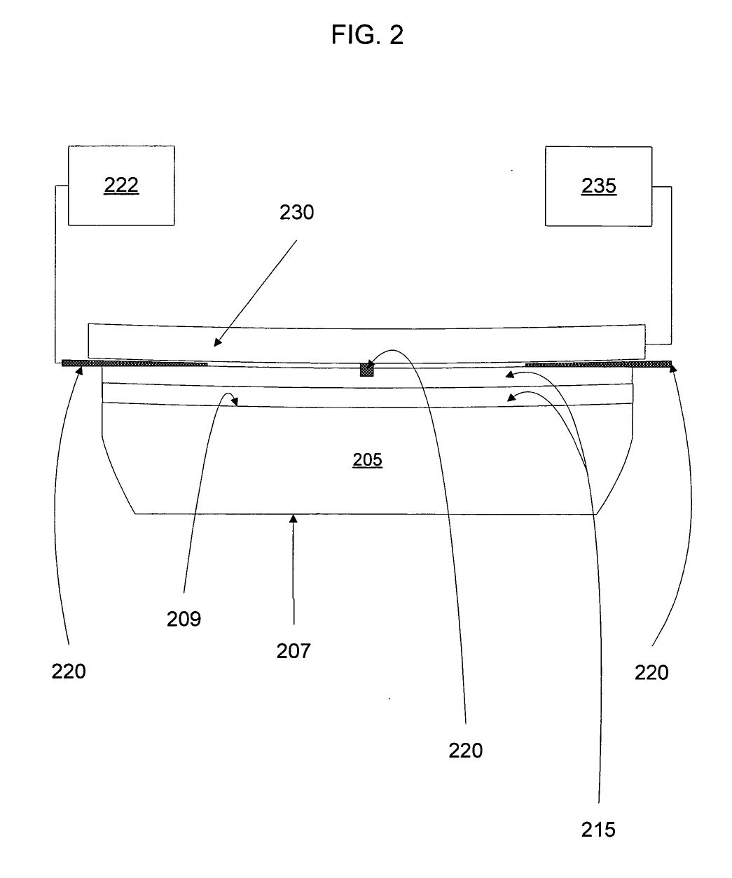

FIG. 2 illustrates an example heating device, according to an example embodiment of the present invention. For example, a cradle 205 may be used. Cradle 205 may have a bottom surface 207 that provides stable support. Cradle 205 may also have a top surface 209 that may be conformed to the shape of the display surface of the monitor. For example, when a touch screen adhered to a conventional CRT monitor is used, the top surface 209 may be formed as a concave surface with a curvature that mirrors the convex surface of the touch screen. If a monitor having a flat display surface is used, then top surface 209 may be formed as a flat surface. Cradle 205 may be formed from any appropriate material that will support the weight of the monitor. For example, materials including metal, wood, plastic, or acrylic may be used. The material may also be heat resistant, flame retardant, and/or flame resistant.

One or more layers of padding 215 may be placed over the top surface 209 of cradle 205. The padding 215 may be formed from a material that is rated for very high temperature use. The padding 215 may also insulate the material of the cradle 205 from high temperatures and prevent melting of the cradle 205. For example, a sheet of silicone foam two centimeters or greater in thickness may be used as padding 215.

In order to monitor the temperature, one or more temperature probes 220, may be positioned on top of the cradle 205. The temperature probes may be placed between the padding layers 215 (as shown in the exemplary embodiment of FIG. 2) and/or on top of the padding 215. The temperature probes 220 may be attached to a temperature controller 222. In one example embodiment, a thermostat controller may be used as the temperature controller. It will be appreciated that any suitable temperature sensing arrangement may be used, which will monitor the temperature and provide feedback so that the applied heat may be controlled.

A heating layer 230 may be placed on the cradle 205, or over the padding 215 and/or the temperature probes 220. The heating layer 230 may be made of any suitable material that may be shaped to conform to the surface of the monitor. For example, if a conventional CRT monitor is used, the top surface of the heating layer 230 may be shaped to have the same spherical radius as the touch screen adhered to the glass on the front of the CRT monitor. The heating layer 230 may be, for example, a conventional, flame retardant silicone heating pad, which is capable of withstanding temperatures of around 500 degrees Celsius. While a silicone heating pad is discussed in these exemplary embodiments, any suitable material may be used for the heating layer, which is capable of attaining temperatures sufficient to soften the adhesive layer. Therefore, the choice of heating layer material may depend on the type of adhesive used to adhere the touch screen to the monitor. A controller 235 may be used to control the temperature of the heating layer. The controller may, for example, allow the temperature to be set to an accuracy of a fraction of a degree. The controller may include, for example, a digital display of the temperature to which the heating layer has been set.

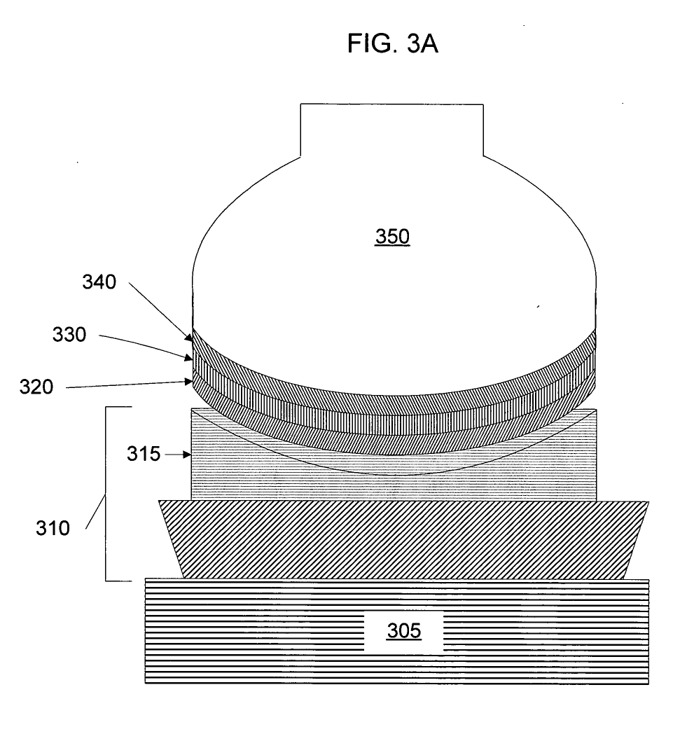

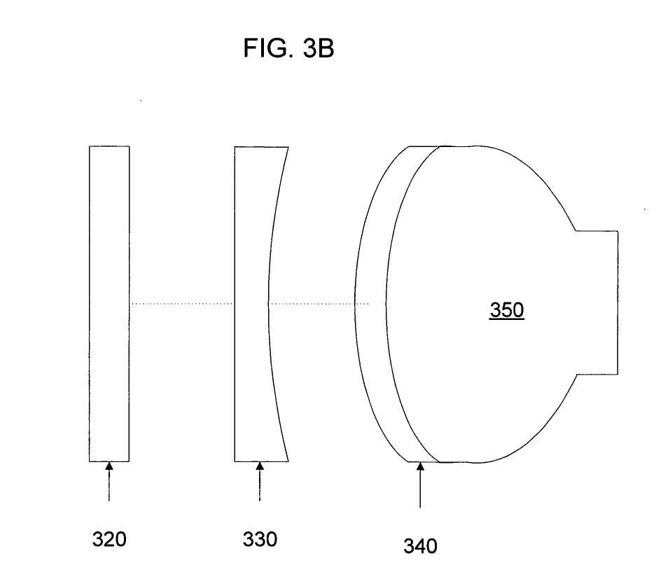

FIG. 3A illustrates an example arrangement of a monitor arranged on the heating device, according to an example embodiment of the present invention. The heating device 310 may be placed on a flat surface 305. The heating device 310 may include the features shown in FIG. 2, which are not shown in detail here, except for the heating layer 315. The touch screen 320 may be made to contact the heating layer 315 by placing the entire monitor 350 on the heating layer 315, with the touch screen 320 facing down and the back of the monitor 350 facing up. Due to the shape of the heating layer 315, the monitor 350 rests in a stable manner on the heating device 310. It is advantageous if the entire outer surface of the touch screen 320 contacts a corresponding part of the heating layer 315. It may increase efficiency to contact the touch screen 320 and the heating layer 315 in as many points as possible. However, it will be appreciated that the heating layer 315 may be placed in close proximity to the touch screen 320 adhered to the front of the monitor 350 in other arrangements, without being in direct contact, however some efficiency may be lost. Close proximity may be, for example, within several centimeters, for example, within 10 centimeters. Additionally, other materials may be placed between the touch screen 320 and the heating layer 315, however, some efficiency may be lost and the heating process may require additional time. For example a transferring layer of material may be placed between the heating layer 315 and the touch screen 320, such that it transfers heat between the heating layer 315 and the touch screen 320. Rather than using the cradle to support the monitor 350, the heating layer 315 may be applied to the front of the monitor 350 in a standing position. Additional securing means, such as heat resistant tape or clamps, may be used to secure the heating layer 315 in contact with or close proximity to the monitor 350.

FIG. 3B illustrates an example monitor 350 after removal of the touch screen 320, according to an example embodiment of the present invention. After heating the front of the monitor 350 with touch screen 320 adhered, and proceeding according to the procedure detailed below, the touch screen 320 may be removed completely intact as indicated in FIG. 3B. Portions of the layer of adhesive 330 may remain on the front surface 340 of the monitor 350. After the layer of adhesive 330 is removed, the monitor then remains, free of the touch screen.

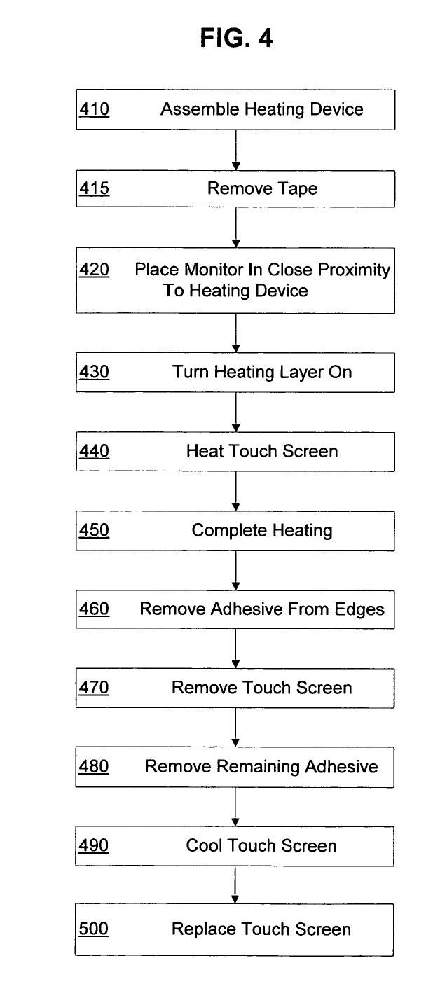

FIG. 4 illustrates an example procedure for removing a touch screen, according to an example embodiment of the present invention. It will be appreciated that the order of the procedure may be varied and that the described procedure is exemplary.

At 410, the heating device may be assembled including the cradle, padding layers, temperature probes and equipment to monitor the temperature probes, and the heating layer. It will be appreciated the heating device may be assembled as described above and shown in FIG. 2, however other arrangements may also be used. For example, fewer, or additional layers of padding may be used, as well as additional devices to facilitate monitoring the heating layer.

At 415, the tape securing the edges of the touch screen may be removed. It will appreciated that there may be securing means other than tape which may be removed before the heating process.

At 420, the monitor may be placed on the heating device or the heating device placed on or in close proximity to the touch screen adhered to the front glass panel of the monitor. The monitor may be positioned so that the touch screen is in contact with the heating pad, as described above and shown in FIG. 3A.

At 430, the heating layer may be made to operate in a heating mode and a thermostat probe or thermocouples may be arranged to monitor the temperature.

At 440, the heating device may be made to heat the touch screen for a time sufficient to break down the adhesive layer, for example, between several minutes and one hour for a touch screen adhered by a typical epoxy adhesive layer. The temperature controller or thermocouples may be monitored and the temperature of the heating layer may be maintained at a particular temperature, or within a particular temperature range. For example, the heating layer may be maintained at a temperature in the range of 100 to 200 degrees Celsius. According to an example embodiment, the heating layer may be maintained at a temperature of 145° C. for 15 minutes. It will be appreciated that care should be taken not to elevate the temperature of the heating layer to or beyond the point at which the adhesive begins to produce smoke; if smoke is detected, the temperature of the heating layer should be lowered. It will be appreciated that ventilation may need to be provided in the area in which the heating device is operated.

At 450, the heating has been completed, the heating pad may be turned off, and the monitor may be placed on a secure surface. It will be appreciated that thermal gloves and safety glasses may be used, as well as any other reasonable measures to prevent injury while handling the objects or surfaces having elevated temperatures.

At 460, any adhesive that has accumulated around the perimeter of the touch screen may be removed. It will be appreciated that this excess adhesive may be removed in any suitable manner, for example, by using an instrument to mechanically scrape the edges.

At 470, the touch screen may be removed from the monitor. For example, a utensil may be inserted into the adhesive layer, which has become somewhat fluid and pliable. The utensil may be inserted between the touch screen and the front surface of the monitor. The utensil may be, for example, a screwdriver or a putty knife. Once the utensil is inserted, a gentle pressure may be applied to the utensil to cause it to create a path or a gap between the touch screen and the glass. It will be appreciated that care may be taken in the amount of force exerted upon the utensil, touch screen, and monitor, to protect both the touch screen and the monitor from damage.

At 480, the touch screen has been removed and any adhesive that remains on the front surface of the monitor may be removed. The remaining adhesive may be removed by using a razor blade, putty knife, or similar instrument to separate the adhesive from the glass. It may be also possible to use a cleaning solution to dissolve the adhesive.

At 490, the monitor may be cooled to room temperature. This may be accomplished by simply allowing time to pass so that the heat may dissipate.

At 500, the monitor may be used for any appropriate use, for example, if another touch screen or other device is to be to be applied to the monitor, it may be applied at this point.

### MODIFICATIONS

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A heating device, comprising:
a heating layer configured to heat a touch screen adhered to a monitor, wherein the monitor is disposed in close proximity to the heating layer.

2. The heating device of claim 1, wherein the heating layer is configured to be placed in direct contact with the touch screen.

3. The heating device of claim 1, wherein the heating layer is configured to be placed in indirect contact with the touch screen.

4. The heating device of claim 1, further comprising:
a cradle having a bottom surface and top surface disposed below the heating layer.

5. The heating device of claim 1, further comprising:
a temperature controller coupled to the heating layer.

6. The heating device of claim 1, further comprising:
a temperature probe disposed in close proximity to the heating layer.

7. The heating device of claim 6, wherein the temperature probe is a thermocouple.

8. The heating device of claim 1, wherein the material of the heating layer includes silicone.

9. The heating device of claim 4, wherein the material of the cradle includes plastic.

10. The heating device of claim 1, wherein the top surface of the heating layer is curved to conform to the outwardly curved surface of a touch screen adhered to the front of a CRT monitor.

11. The heating device of claim 4, further comprising:
at least one padding layer disposed on top of the cradle.

12. The heating device of claim 4, further comprising:
at least one insulating layer disposed on top of the cradle.

13. A heating device, comprising:
means to heat a touch screen adhered to a monitor that is disposed in close proximity to the heating means; and
means to monitor the temperature of the heating means.

14. The heating device of claim 13, wherein the heating means is configured to be placed in contact with the touch screen.

15. A heating device for use in removing a touch screen from a monitor, comprising:
a heating layer configured to be disposed in close proximity to the monitor;
a cradle having a bottom surface and top surface disposed below the heating layer;
a temperature controller coupled to the heating layer; and
a temperature probe disposed in close proximity to the heating layer.

16. A method for removing a touch screen from a monitor, comprising:
disposing the monitor in close proximity to the heating layer so that a touch screen adhered to the monitor is in contact with the heating layer;
heating the touch screen; and
removing the touch screen from the monitor.

17. The method for removing a touch screen of claim 16, further comprising:
measuring the temperature of the heating layer.

18. The method for removing a touch screen of claim 16, further comprising:
disposing an instrument between the touch screen and the monitor and applying a force to the instrument to separate the touch screen from the monitor.

19. The method for removing a touch screen of claim 16, further comprising:
after removing the touch screen, removing material remaining on the front surface of the monitor by mechanically scraping the material off of the monitor.

20. The method for removing a touch screen of claim 16, further comprising:
after removing the touch screen, removing material remaining on the front surface of the monitor by chemically dissolving the material off of the monitor.

21. The method for removing a touch screen of claim 16, wherein the touch screen is removed while the front surface of the monitor has an elevated temperature.

22. The method for removing a touch screen of claim 16, wherein the surface of the touch screen is heated for a time interval between 5 minutes and one hour.

23. The method for removing a touch screen of claim 16, wherein the surface of the touch screen is heated to a temperature of not more than 145° C.

24. A system for replacing a touch screen adhered to a monitor, comprising:
a heating layer configured to heat a touch screen; and
a probe arrangement configured to monitor the temperature of the touch screen.

25. The system for replacing a touch screen of claim 24, further comprising:
a support including a cradle disposed below the heating layer.

26. The system for replacing a touch screen of claim 24, further comprising:
a padding layer disposed on the cradle.

27. The system for replacing a touch screen of claim 24, wherein the probe arrangement includes a thermocouple.

28. The system for replacing a touch screen of claim 24, further comprising:
a transferring layer configured to conduct heat from the heating layer to the touch screen.

29. The heating device of claim 4, wherein the top surface of the cradle is conformed to the shape of the touch screen.

30. The heating device of claim 29, wherein the top surface of the cradle has substantially the same curvature of the touch screen.

31. The heating device of claim 29, wherein the top surface of the cradle is substantially flat.

32. The heating device of claim 1, wherein the heating layer is configured to heat the touch screen by placing the monitor on the heating layer, with the touch screen facing down.

33. The heating device of claim 1, wherein the heating layer is configured to heat the touch screen by applying the heating layer to the front of the monitor in a standing position.

34. The heating device of claim 33, further comprising:
means for securing the heating layer to the monitor.

35. The heating device of claim 33, further comprising:
heat resistant tape adapted to secure the heating layer to the monitor.

36. The heating device of claim 2, wherein the heating layer is curved to conform to the surface of the touch screen.

37. The heating device of claim 1, wherein the heating layer is configured to heat the touch screen adhered to a monitor non-destructively.

38. The method of claim 16, further comprising:
reducing the effectiveness of the adhesive adhering the touch screen to the monitor as a result of heating the touch screen.

39. The method of claim 16, wherein the touch screen and monitor are heated non-destructively.

40. A heating device for use in removing a touch screen from a monitor, comprising:
a heating layer configured to be disposed in close proximity to the touch screen and to non-destructively heat the touch screen and monitor so that the effectiveness of an adhesive adhering the touch screen to the monitor is reduced;
a cradle having a bottom surface and top surface disposed below the heating layer;
a temperature controller coupled to the heating layer; and
a temperature probe disposed in close proximity to the heating layer.
